(19) United States
(12) Patent Application Publication
(10) Pub. No.: US 2022/0230343 A1
(43) Pub. Date: Jul. 21, 2022

(54) STEREO MATCHING METHOD, MODEL TRAINING METHOD, RELEVANT ELECTRONIC DEVICES

(71) Applicant: Beijing Baidu Netcom Science Technology Co., Ltd., Beijing (CN)

(72) Inventors: Xiaoqing Ye, Beijing (CN); Xiao Tan, Beijing (CN); Hao Sun, Beijing (CN)

(73) Assignee: Beijing Baidu Netcom Science Technology Co., Ltd., Beijing (CN)

(21) Appl. No.: 17/709,291

(22) Filed: Mar. 30, 2022

(30) Foreign Application Priority Data
Aug. 25, 2021 (CN) 202110980247.4

(51) Int. Cl. G06T 7/593

(52) U.S. Cl. CPC G06T 7/593; G06T 2207/20081; G06T 2207/20084; G06T 2207/10012

(57) ABSTRACT

A computer-implemented stereo matching method includes: obtaining a first binocular image; inputting the first binocular image into an object model for a first operation to obtain a first initial disparity map and a first offset disparity map with respect to the first initial disparity map; and performing aggregation on the first initial disparity map and the first offset disparity map to obtain a first target disparity map of the first binocular image. The first initial disparity map is obtained through stereo matching on a second binocular image corresponding to the first binocular image, a size of the second binocular image is smaller than a size of the first binocular image, and the first offset disparity map is obtained through stereo matching on the first binocular image within a predetermined disparity offset range.

### CROSS-REFERENCE TO RELATED APPLICATION

This application claims a priority of the Chinese Patent Application No. 202110980247.4 filed on Aug. 25, 2021, which is incorporated herein by reference in its entirety.

### TECHNICAL FIELD

The present disclosure relates to the field of artificial intelligent technology, in particular to the field of computer vision technology and deep learning technology, more particularly to a stereo matching method, a model training method, and relevant electronic devices.

### BACKGROUND

Along with the rapid development of the image processing technology, a stereo matching technology has been widely used. The stereo matching technology refers to obtaining a disparity map of a binocular image in a same scenario, so as to obtain a depth map of the binocular image.

Currently, the stereo matching is performed on the binocular image using a deep learning model. To be specific, a cost volume for the stereo matching on the binocular image is calculated through the deep learning model, and then cost aggregation is performed through three-dimensional (3D) convolution in accordance with the cost volume, so as to obtain the disparity map of the binocular image.

### SUMMARY

An object of the present disclosure is to provide a stereo matching method, a model training method, and relevant electronic devices, so as to solve problems in the related art.

In a first aspect, the present disclosure provides in some embodiments a computer-implemented stereo matching method, including: obtaining a first binocular image; inputting the first binocular image into an object model for a first operation to obtain a first initial disparity map and a first offset disparity map with respect to the first initial disparity map; and performing aggregation on the first initial disparity map and the first offset disparity map to obtain a first target disparity map of the first binocular image. The first initial disparity map is obtained through stereo matching on a second binocular image corresponding to the first binocular image, a size of the second binocular image is smaller than a size of the first binocular image, and the first offset disparity map is obtained through stereo matching on the first binocular image within a predetermined disparity offset range.

In a second aspect, the present disclosure provides in some embodiments a computer-implemented model training method, including: obtaining a train sample image, the train sample image including a third binocular image and a label disparity map of the third binocular image; inputting the third binocular image into an object model for a second operation to obtain a third initial disparity map of the third binocular image and a second offset disparity map with respect to the third initial disparity map, the third initial disparity map being obtained through stereo matching on a fourth binocular image corresponding to the third binocular image, a size of the fourth binocular image being smaller than a size of the third binocular image, the second offset disparity map being obtained through stereo matching on the third binocular image within a predetermined disparity offset range; obtaining a network loss of the object model in accordance with the third initial disparity map, the second offset disparity map and the label disparity map; and updating a network parameter of the object model in accordance with the network loss.

In a third aspect, the present disclosure provides in some embodiments a stereo matching device, including: a first obtaining module configured to obtain a first binocular image; a first operating module configured to input the first binocular image into an object model for a first operation to obtain a first initial disparity map and a first offset disparity map with respect to the first initial disparity map; and a first aggregation module configured to perform aggregation on the first initial disparity map and the first offset disparity map to obtain a first target disparity map of the first binocular image. The first initial disparity map is obtained through stereo matching on a second binocular image corresponding to the first binocular image, a size of the second binocular image is smaller than a size of the first binocular image, and the first offset disparity map is obtained through stereo matching on the first binocular image within a predetermined disparity offset range.

In a fourth aspect, the present disclosure provides in some embodiments a model training device, including: a second obtaining module configured to obtain a train sample image, the train sample image including a third binocular image and a label disparity map of the third binocular image; a second operating module configured to input the third binocular image into an object model for a second operation to obtain a third initial disparity map of the third binocular image and a second offset disparity map with respect to the third initial disparity map, the third initial disparity map being obtained through stereo matching on a fourth binocular image corresponding to the third binocular image, a size of the fourth binocular image being smaller than a size of the third binocular image, the second offset disparity map being obtained through stereo matching on the third binocular image within a predetermined disparity offset range; a third obtaining module configured to obtain a network loss of the object model in accordance with the third initial disparity map, the second offset disparity map and the label disparity map; and an updating module configured to update a network parameter of the object model in accordance with the network loss.

In a fifth aspect, the present disclosure provides in some embodiments an electronic device, including at least one processor, and a memory in communication with the at least one processor. The memory is configured to store therein an instruction to be executed by the at least one processor, and the instruction is executed by the at least one processor so as to implement the computer-implemented stereo matching method in the first aspect, or the computer-implemented model training method in the second aspect.

In a sixth aspect, the present disclosure provides in some embodiments a non-transitory computer-readable storage medium storing therein a computer instruction. The computer instruction is executed by a computer so as to implement the computer-implemented stereo matching method in the first aspect, or the computer-implemented model training method in the second aspect.

In a seventh aspect, the present disclosure provides in some embodiments a computer program product including a computer program. The computer program is executed by a processor so as to implement the computer-implemented stereo matching method in the first aspect, or the computer-implemented model training method in the second aspect.

According to the embodiments of the present disclosure, it is able to reduce a computational burden of the stereo matching while ensuring the accuracy thereof.

It should be understood that, this summary is not intended to identify key features or essential features of the embodiments of the present disclosure, nor is it intended to be used to limit the scope of the present disclosure. Other features of the present disclosure will become more comprehensible with reference to the following description.

### BRIEF DESCRIPTION OF THE DRAWINGS

The following drawings are provided to facilitate the understanding of the present disclosure, but shall not be construed as limiting the present disclosure. In these drawings,

FIG. 1 is a flow chart of a stereo matching method according to a first embodiment of the present disclosure;

FIG. 2 is a schematic view showing the stereo matching performed by an object model according to one embodiment of the present disclosure;

FIG. 3 is a flow chart of a model training method according to a second embodiment of the present disclosure;

FIG. 4 is a schematic view showing a stereo matching device according to a third embodiment of the present disclosure;

FIG. 5 is a schematic view showing a model training device according to a fourth embodiment of the present disclosure; and

FIG. 6 is a block diagram of an electronic device according to one embodiment of the present disclosure.

### DETAILED DESCRIPTION

In the following description, numerous details of the embodiments of the present disclosure, which should be deemed merely as exemplary, are set forth with reference to accompanying drawings to provide a thorough understanding of the embodiments of the present disclosure. Therefore, those skilled in the art will appreciate that modifications or replacements may be made in the described embodiments without departing from the scope and spirit of the present disclosure. Further, for clarity and conciseness, descriptions of known functions and structures are omitted.

### First Embodiment

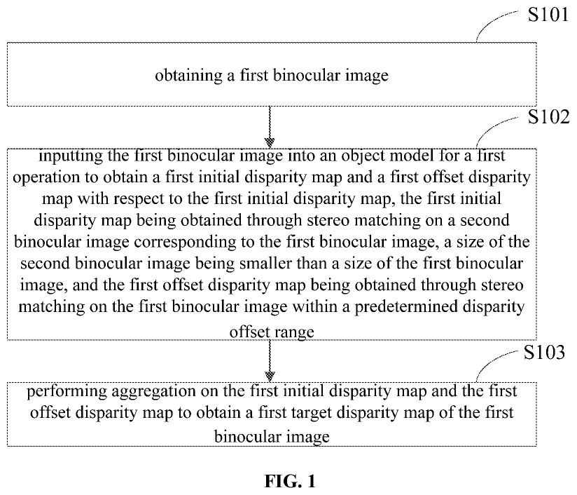

As shown in FIG. 1, the present disclosure provides in this embodiment a computer-implemented stereo matching method, which includes the following steps.

S101: obtaining a first binocular image.

In the first embodiment, the stereo matching method relates to the field of Artificial Intelligence (AI) technology, in particular to the field of computer vision technology and deep learning technology, and it may be widely applied in such scenarios as 3D reconstruction, stereo navigation and non-contact distance measurement. The stereo matching method may be implemented by a stereo matching device in the embodiments of the present disclosure. The stereo matching device may be provided in any electronic device, so as to implement the stereo matching method. The electronic device may be a server or a terminal, which will not be particularly defined herein.

The first binocular image refers to left and right viewpoint images captured by a binocular camera in a same scenario, and it includes at least one left-eye image and at least one right-eye image. The left-eye image is a left viewpoint image, and the right-eye image is a right viewpoint image. In addition, the images in the first binocular image have same parameters, e.g., size and resolution. An object of the present disclosure is to provide a new stereo matching scheme, so as to determine a disparity map of the left-eye image and the right-eye image, thereby to reduce a computational burden of the stereo matching while ensuring the accuracy thereof.

The first binocular image may be obtained in various ways. For example, a binocular image in a same scenario is directly captured by the binocular camera as the first binocular image, or a pre-stored binocular image is obtained as the first binocular image, or a binocular image is received from the other electronic device as the first binocular image, or a binocular image is downloaded from a network as the first binocular image.

S102: inputting the first binocular image into an object model for a first operation to obtain a first initial disparity map and a first offset disparity map with respect to the first initial disparity map. The first initial disparity map is obtained through stereo matching on a second binocular image corresponding to the first binocular image, a size of the second binocular image is smaller than a size of the first binocular image, and the first offset disparity map is obtained through stereo matching on the first binocular image within a predetermined disparity offset range.

In this step, the object model may be a neural network model, e.g., a convolutional neural network or a residual neural network ResNet. The object model is configured to perform stereo matching on the binocular image so as to obtain the disparity map of the binocular image.

The object model may include two parts. A first part may be a conventional or new stereo matching network configured to predict an initial disparity map of the first binocular image, and a second part may be connected in series to the stereo matching network and configured to predict an offset disparity map of the first binocular image.

The first binocular image may be inputted into the object model for the first operation. Correspondingly, the first operation may also include two parts. In a first part, with respect to the stereo matching model, the stereo matching is performed on the second binocular image determined in accordance with the first binocular image, so as to obtain the first initial disparity map. In a second part, with respect to the network connected in series to a stereo matching network, on the basis of the first initial disparity map, an offset value of the first initial disparity map is predicted in accordance with the first binocular image, so as to obtain the first offset disparity map.

The second binocular image is a binocular image in a same scenario as the first binocular image, and the size of the second binocular image is smaller than the size of the first binocular image.

In a possible embodiment of the present disclosure, first adjustment is performed on the first binocular image, i.e., the first binocular image is resized, so as to reduce the size of the first binocular image, thereby to obtain the second binocular image. For example, when the size of the first binocular image is W*H, the size of the first binocular image is adjusted to

$$\frac{W}{N} \times \frac{H}{N} ,$$

i.e., the first binocular image is resized by a factor of 1/N, so as to obtain the second binocular image having a size of

$$\frac{W}{N} \times \frac{H}{N} .$$

In another possible embodiment of the present disclosure, the first binocular image is down-sampled, so as to reduce the size of the first binocular image, thereby to obtain the second binocular image. For example, the first binocular image is down-sampled on an x-axis and a y-axis by a factor of 1/N, so as to obtain the second binocular image having a size of

$$\frac{W}{N} \times \frac{H}{N} .$$

The disparity map of the second binocular image is predicted by the stereo matching network using an existing or new stereo matching scheme, so as to obtain the first initial disparity map of the first binocular image. In a possible embodiment of the present disclosure, with respect to each pixel point in the first binocular image, a matching cost is calculated within a maximum disparity range of the second binocular image, so as to obtain a cost volume for the pixel point. Next, cost aggregation is performed on the cost volume using 3D convolution, so as to obtain a cost-aggregated cost volume. Then, a disparity probability is predicted in accordance with the cost-aggregated cost volume. To be specific, with respect to each pixel point, a confidence level, represented by pᵢ, of each disparity value of the pixel point within the maximum disparity range is solved through Softmin, where i represents a disparity value of the second binocular image within the maximum disparity range. Finally, an optimal disparity value of each pixel point in the second binocular image is determined in accordance with the predicted probability and the maximum disparity range through the following formula: D_{coarse}^{1/N}=Σᵢ₌₁^{D}^{ₘₐₓ}^{′}pᵢDᵢ (1), where D_{coarse}^{1/N} is the disparity map of the second binocular image, Dₘₐₓ′ is a maximum disparity value of the second binocular image, the maximum disparity range of the second binocular image is 1˜Dₘₐₓ′, and Dᵢ is the disparity value within the maximum disparity range.

Then, the first initial disparity map of the first binocular image is determined in accordance with the disparity map of the second binocular image. In a possible embodiment of the present disclosure, second adjustment is performed on the disparity map of the second binocular image, i.e., the disparity map of the second binocular image is resized, so as to increase a size of the disparity map of the second binocular image. The first adjustment corresponds to the second adjustment. For example, when the first adjustment includes resizing the first binocular image by a factor of 1/N, the second adjustment includes resizing the disparity map of the second binocular image by a factor of N. After the resizing, a disparity value of each pixel point in the resized disparity map is adjusted, so as to obtain the first initial disparity map. For example, the disparity value of each pixel point is multiplied by N, so as to obtain the first initial disparity map D_{coarse}.

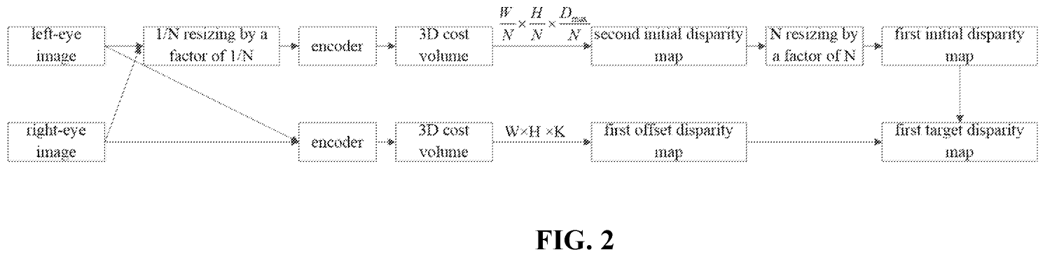

As shown in FIG. 2, the first initial disparity map of the first binocular image is determined by an upper part of the network through resizing and stereo matching.

In yet another possible embodiment of the present disclosure, the disparity map of the second binocular image is up-sampled, e.g., up-sampled on the x-axis and the y-axis by a factor 1/N, so as to obtain a disparity map having a size of W*H. After the up-sampling, a disparity value of each pixel point in the up-sampled disparity map is adjusted to obtain the first initial disparity map. For example, the disparity value of each pixel point is multiplied by N so as to obtain the first initial disparity map. The first initial disparity map includes an optimal disparity value of each pixel point in the first binocular image predicted in accordance with the second binocular image.

In this step, when the first binocular image has a size of W*H, the maximum disparity value is Dₘₐₓ, and the cost volume is W×H×Dₘₐₓ. When the cost aggregation is performed through 3D convolution, its computational burden is G(WHDₘₐₓ), which is very big. When the first binocular image is resized by a factor of 1/N, the obtained second binocular image has a size of

$$\frac{W}{N} \times \frac{H}{N} ,$$

and its maximum disparity value Dₘₐₓ′ is 1/N of the maximum disparity value Dₘₐₓ of the first binocular image, the cost volume is

$$\frac{W}{N} \times \frac{H}{N} \times \frac{{D}_{max}}{N} ,$$

and the computational burden is O(WHDₘₐₓ/N³). Hence, through performing the stereo matching on the second binocular image to obtain the first initial disparity map of the first binocular image, it is remarkably reduce the computational burden for the stereo matching.

A resolution of the binocular image is reduced during the stereo matching, so a resolution of the disparity map is reduced too. In order to ensure the accuracy of the stereo matching, another network may be connected in series to the stereo matching network, so as to predict the first offset disparity map of the first binocular image on the basis of the first initial disparity map. For example, the first initial disparity map is D_{coarse}, and with respect to each pixel point in D_{coarse}, an offset value relative to the optimal disparity vale of the pixel point in the first initial disparity map may be estimated, so as to obtain the first offset disparity map.

To be specific, the network may constrain a disparity search range. When an input image has a size of W*H, the estimated cost volume may have a size of W*H*K, where K represents a maximum disparity value within the disparity search range.

In a conventional stereo matching network, usually the disparity search range is a maximum disparity range, e.g., 1 to 128 or 1 to 256. The disparity search range of the network may be constrained to a predetermined disparity offset range. K represents a maximum offset value estimated with respect to each disparity value within the maximum disparity range of the first binocular image, and a value of K is far less than Dₘₐₓ, e.g., K is 10 or 20.

In a possible embodiment of the present disclosure, when K is 10, the predetermined disparity offset range may be set as [−10,−5,−3,−2,−1,0,1,2,3,5,10]. In other words, with respect to each pixel point in the first binocular image, each disparity value within the maximum disparity range may be offset by a maximum value of 10, and 10 disparity offset values may be set, i.e., an absolute value of each of the 10 disparity offset values is smaller than or equal to the maximum offset value. When the predetermined disparity offset range is larger, the resultant first offset disparity map is more accurate, and when the predetermined disparity offset range is smaller, an error of the resultant first offset disparity map is larger.

Then, a disparity probability is predicted in accordance with the cost volume W*H*K. To be specific, with respect to each pixel point, a confidence level, represented by qᵢ, of each disparity value of the pixel point within the predetermined disparity offset range is solved through Softmin, where i represents an i^{th} disparity value within the predetermined disparity offset range. Finally, an optimal offset value of an optimal disparity value of the pixel point in the first initial disparity map is determined in accordance with the predicted probability and the predetermined disparity offset range to obtain the first offset disparity map through the following formula: D_{offset}=Σᵢ₌₁^{K}qᵢLᵢ (2), where D_{offset} represents the first offset disparity map, and Lᵢ represents the predetermined disparity offset range, e.g., [−10,−5,−3,−2,−1,0,1,2,3,5,10].

As shown in FIG. 2, the disparity search change is constrained by a lower part of the network, i.e., the network connected in series to the stereo matching network, so as to predict the disparity offset value with respect to the first initial disparity map, thereby to obtain the first offset disparity map.

S103: performing aggregation on the first initial disparity map and the first offset disparity map to obtain a first target disparity map of the first binocular image.

In this step, the aggregation is performed on the first initial disparity map and the first offset disparity map. To be specific, with respect to each pixel point in the first initial disparity map, a sum of a disparity value of the pixel point and a disparity offset value of a pixel point in the first offset disparity map corresponding to the pixel point is calculated, so as to obtain the first target disparity map of the first binocular image. The first target disparity map is an optimal disparity map predicted by the object model with respect to the first binocular image, and it is calculated through the following formula: D_{final}=D_{coarse}+D_{offset} (3).

It should be appreciated that, before use, the object model needs to be trained, so as to learn a network parameter of the object model, and a training process will be described hereinafter in details.

In the embodiments of the present disclosure, the size of the binocular image is reduced and then the stereo matching is performed, so as to obtain the first initial disparity map, thereby to remarkably reduce the computational burden for the stereo matching. In addition, a network is connected in series to the stereo matching network, so as to constrain the disparity search range and predict the disparity offset value with respect to the first initial disparity map, thereby to obtain the first offset disparity map. Then, the aggregation is performed on the first initial disparity map and the first offset disparity map. As a result, it is able to remarkably reduce the computational burden for the stereo matching while ensuring the accuracy of the stereo matching, thereby to accelerate the stereo matching.

In a possible embodiment of the present disclosure, the inputting the first binocular image into the object model for the first operation to obtain the first initial disparity map of the first binocular image includes: performing first adjustment on the size of the first binocular image to obtain the second binocular image, the first adjustment being used to reduce the size of the first binocular image; performing stereo matching on the second binocular image within a maximum disparity range of the second binocular image to obtain a second initial disparity map of the second binocular image; performing second adjustment on a size of the second initial disparity map, the second adjustment being used to increase the size of the second disparity map, the first adjustment corresponding to the second adjustment; and adjusting a disparity value of each pixel point in the second initial disparity map obtained through the second adjustment, so as to obtain the first initial disparity map.

In the embodiments of the present disclosure, the first adjustment is performed on the first binocular image, i.e., the first binocular image is resized, so as to reduce the size of the first binocular image, thereby to obtain the second binocular image. For example, when the size of the first binocular image is W*H, the size of the first binocular image is adjusted to

$$\frac{W}{N} \times \frac{H}{N} ,$$

i.e., the first binocular image is resized by a factor of 1/N, so as to obtain the second binocular image having a size of

$$\frac{W}{N} \times \frac{H}{N} .$$

The second initial disparity map is predicted by the stereo matching network using an existing or new stereo matching scheme. In a possible embodiment of the present disclosure, with respect to each pixel point in the first binocular image, a matching cost is calculated within a maximum disparity range of the second binocular image, so as to obtain a cost volume for the pixel point. Next, cost aggregation is performed on the cost volume using 3D convolution, so as to obtain a cost-aggregated cost volume. Then, a disparity probability is predicted in accordance with the cost-aggregated cost volume. To be specific, with respect to each pixel point, a confidence level of each disparity value of the pixel point within the maximum disparity range is solved through Softmin. Finally, an optimal disparity value of each pixel point in the second binocular image is determined in accordance with the predicted probability and the maximum disparity range so as to obtain the second initial disparity map.

Then, the first initial disparity map is determined in accordance with the second initial disparity map. To be specific, the second adjustment is performed on the second initial disparity map, i.e., the second initial disparity map is resized, so as to increase the size of the second initial disparity map. The first adjustment corresponds to the second adjustment. For example, when the first adjustment includes resizing the first binocular image by a factor of 1/N, the second adjustment includes resizing the disparity map of the second binocular image by a factor of N. After the resizing, a disparity value of each pixel point in the resized second initial disparity map is adjusted, so as to obtain the first initial disparity map. For example, the disparity value of each pixel point is multiplied by N, so as to obtain the first initial disparity map D_{coarse}.

According to the first embodiment of the present disclosure, the first adjustment is performed on the size of the first binocular image to obtain the second binocular image, and the first adjustment is used to reduce the size of the first binocular image. The stereo matching is performed in accordance with the second binocular image within the maximum disparity range of the second binocular image, so as to obtain the second initial disparity map of the second binocular image. The second adjustment is performed on the size of the second initial disparity map, the second adjustment is used to increase the size of the second initial disparity map, and the first adjustment corresponds to the second adjustment. Then, the disparity value of each pixel point in the second initial disparity map obtained after the second adjustment is adjusted, so as to obtain the first initial disparity map. As a result, through resizing the binocular image and performing the stereo matching on the resized binocular image, it is able to remarkably reduce the computational burden for the stereo matching while determining the first initial disparity map in a simple manner.

### Second Embodiment

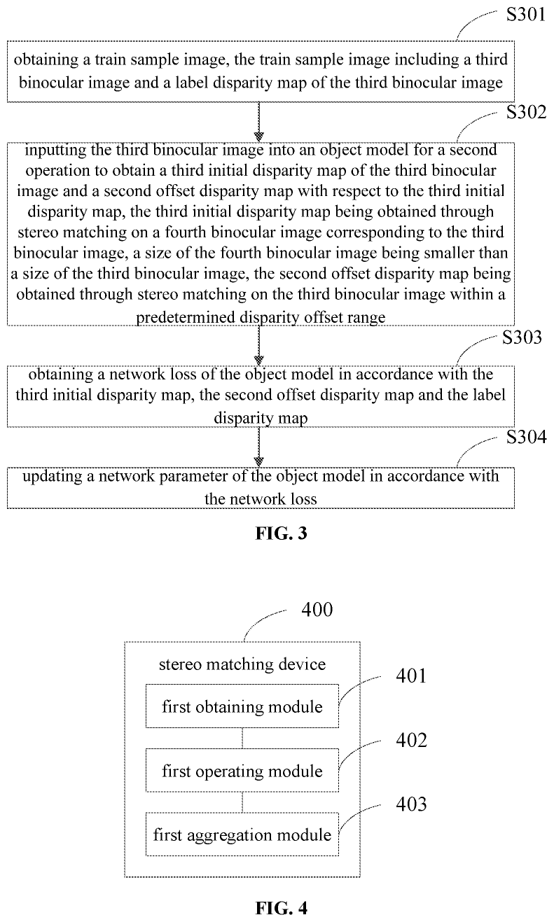

As shown in FIG. 3, the present disclosure provides in this embodiment a computer-implemented model training method, which includes: S301 of obtaining a train sample image, the train sample image including a third binocular image and a label disparity map of the third binocular image; S302 of inputting the third binocular image into an object model for a second operation to obtain a third initial disparity map of the third binocular image and a second offset disparity map with respect to the third initial disparity map, the third initial disparity map being obtained through stereo matching on a fourth binocular image corresponding to the third binocular image, a size of the fourth binocular image being smaller than a size of the third binocular image, the second offset disparity map being obtained through stereo matching on the third binocular image within a predetermined disparity offset range; S303 of obtaining a network loss of the object model in accordance with the third initial disparity map, the second offset disparity map and the label disparity map; and S304 of updating a network parameter of the object model in accordance with the network loss.

A training procedure of the object model is described in this embodiment.

In S301, the train sample image may include a plurality of third binocular images and a label disparity map of each third binocular image.

The third binocular image in the train sample data may be obtained in one or more ways. For example, a binocular image may be directly captured by a binocular camera as the third binocular image, or a pre-stored binocular image may be obtained as the third binocular image, or a binocular image may be received from the other electronic device as the third binocular image, or a binocular image may be downloaded from a network as the third binocular image.

The label disparity map of the third binocular image may refer to an actual disparity map, i.e., a real disparity map, of the third binocular image, and it has high precision. The label disparity map may be obtained in various ways. For example, in the case that a depth map of the third binocular image has been determined accurately, the label disparity map of the third binocular image may be determined in accordance with the depth map; or the pre-stored label disparity map of the third binocular image may be obtained; or the label disparity map of the third binocular image may be received from the other electronic device.

In S302, the third binocular image may be inputted into the object model for the second operation, so as to obtain the third initial disparity map of the third binocular image and the second offset disparity map with respect to the third initial disparity map. The second operation is similar to the first operation, and thus will not be particularly defined herein.

In a possible embodiment of the present disclosure, the inputting the third binocular image into the object model for the second operation to obtain the third initial disparity map of the third binocular image includes: performing first adjustment on the size of the third binocular image to obtain the fourth binocular image, the first adjustment being used to reduce the size of the third binocular image; performing stereo matching in accordance with the fourth binocular image within a maximum disparity range of the fourth binocular image, so as to obtain a fourth initial disparity map of the fourth binocular image; performing second adjustment on a size of the fourth initial disparity map, the second adjustment being used to increase the size of the fourth initial disparity map, the first adjustment corresponding to the second adjustment; and adjusting a disparity value of each pixel point in the fourth initial disparity map obtained after the second adjustment, so as to obtain the third initial disparity map.

In S303, the network loss of the object model may be obtained in accordance with the third initial disparity map, the second offset disparity map and the label disparity map. In a possible embodiment of the present disclosure, a first loss between the label disparity map and the third initial disparity map and a second loss between the label disparity map and the second offset disparity map are determined, then the first loss and the second loss are aggregated to obtain a disparity loss, and then the network loss is determined in accordance with the disparity loss. The disparity loss refers to a difference between the disparity map predicted by the object model and the label disparity map.

During the implementation, through an image processing technology, a difference between the label disparity map and the third initial disparity map is determined so as to obtain the first loss, and a difference between the label disparity map and the second offset disparity map is determined so as to obtain the second loss. Alternatively, a smooth loss between the label disparity map and the third initial disparity map is calculated through the following formula:

$${L}_{{D}_{coarse}} = \frac{1}{Q} {\sum }_{i = 0}^{Q} smoothL 1 ( \hat{d} - d ) , \qquad ( 4 )$$

and a smooth loss between the label disparity map and the second offset disparity map is calculated, where L_{D}_{_{coarse}} represents the smooth loss between the label disparity map and the third initial disparity map, a represents a disparity value in the third initial disparity map, d represents a disparity value in the label disparity map, and Q represents the quantity of pixel points.

The smooth loss L_{D}_{_{final}} between the label disparity map and the second offset disparity map is calculated through a formula similar to (4), which will thus not be particularly defined herein.

In another possible embodiment of the present disclosure, the third initial disparity map and the second offset disparity map are aggregated to obtain a second target disparity map of the third binocular image, a smooth loss between the label disparity map and the second target disparity map is calculated, and then the network loss is determined in accordance with the smooth loss.

In S304, the network parameter of the object model may be updated through a gradient descent method in accordance with the network loss. When the network loss is greater than a predetermined threshold, it means that the network parameter of the object model fails to meet the accuracy requirement on the stereo matching. At this time, the network parameter of the object model may be updated through the gradient descent method in accordance with the network loss, and the object model may be trained in accordance with the updated network parameter. When the network loss is smaller than or equal to a predetermined threshold and convergence has been achieved, it means that the network parameter of the object model has met the accuracy requirement on the stereo matching. At this time, the training may be ended.

According to the embodiments of the present disclosure, the train sample image is obtained, and it includes the third binocular image and the label disparity map of the third binocular image. Next, the third binocular image is inputted into the object model for the second operation, so as to obtain the third initial disparity map of the third binocular image and the second offset disparity map with respect to the third initial disparity map. The third initial disparity map is obtained through stereo matching on the fourth binocular image corresponding to the third binocular image, the size of the fourth binocular image is smaller than the size of the third binocular image, and the second offset disparity map is obtained through stereo matching on the third binocular image within the predetermined disparity offset range. Next, the network loss of the object model is obtained in accordance with the third initial disparity map, the second offset disparity map and the label disparity map. Then, the network parameter of the object model is updated in accordance with the network loss. As a result, it is able to train the object model and perform the stereo matching on the binocular image through the object model, thereby to reduce the computational burden for the stereo matching while ensuring the accuracy of the stereo matching.

In a possible embodiment of the present disclosure, S303 specifically includes: obtaining a first loss between the label disparity map and the third initial disparity map and a second loss between the label disparity map and the second offset disparity map; performing aggregation on the first loss and the second loss to obtain a disparity loss; and determining the network loss in accordance with the disparity loss.

During the implementation, the first loss between the label disparity map and the third initial disparity map and the second loss between the label disparity map and the second offset disparity map are determined, then the first loss and the second loss are aggregated to obtain the disparity loss, and then the network loss is determined in accordance with the disparity loss. In this way, it is able to train the object model through determining the disparity loss.

In a possible embodiment of the present disclosure, prior to determining the network loss in accordance with the disparity loss, the model training method further includes: performing aggregation on the third initial disparity map and the second offset disparity map to obtain a second target disparity map of the third binocular image; and determining a smooth loss of the second target disparity map in accordance with an image gradient of the third binocular image and an image gradient of the second target disparity map. The determining the network loss in accordance with the disparity loss includes performing aggregation on the disparity loss and the smooth loss to obtain the network loss.

During the implementation, the second target disparity map is a full-size map, so it is necessary to pay attention to smoothness of the entire image. Hence, as shown in FIG. 2, the network loss may be obtained through superimposing the smooth loss of the image on the disparity loss. The smooth loss of the second target disparity map is calculated through the following formula:

$${L}_{s m o o t h} = \vert \frac{\partial \hat{d 1}}{\partial x} \vert {e}^{- \vert \frac{\partial I}{\partial x} \vert} + \vert \frac{\partial \hat{d 1}}{\partial y} \vert {e}^{- \vert \frac{\partial I}{\partial γ} \vert ,} \qquad ( 5 )$$

where Lₛₘₒₒₜₕ represents the smooth loss of the second target disparity map, [symbol] represents the second target disparity map, I represents the label disparity map,

$$\frac{\partial *}{\partial x}$$

represents a gradient of the image in an x-axis direction, and

$$\frac{\partial *}{\partial y}$$

represents a gradient of the image in a y-axis direction.

In the embodiments of the present disclosure, the network loss is obtained through superimposing the smooth loss of the image on the disparity loss, and then the network parameter of the object model is updated in accordance with the network loss, so as to improve a training effect of the object model.

### Third Embodiment

As shown in FIG. 4, the present disclosure provides in this embodiment a stereo matching device 400, which includes: a first obtaining module 401 configured to obtain a first binocular image; a first operating module 402 configured to input the first binocular image into an object model for a first operation to obtain a first initial disparity map and a first offset disparity map with respect to the first initial disparity map; and a first aggregation module 403 configured to perform aggregation on the first initial disparity map and the first offset disparity map to obtain a first target disparity map of the first binocular image. The first initial disparity map is obtained through stereo matching on a second binocular image corresponding to the first binocular image, a size of the second binocular image is smaller than a size of the first binocular image, and the first offset disparity map is obtained through stereo matching on the first binocular image within a predetermined disparity offset range.

In a possible embodiment of the present disclosure, the first operating module 402 is specifically configured to: perform first adjustment on the size of the first binocular image to obtain the second binocular image, the first adjustment being used to reduce the size of the first binocular image; perform stereo matching on the second binocular image within a maximum disparity range of the second binocular image to obtain a second initial disparity map of the second binocular image; perform second adjustment on a size of the second initial disparity map, the second adjustment being used to increase the size of the second disparity map, the first adjustment corresponding to the second adjustment; and adjust a disparity value of each pixel point in the second initial disparity map obtained through the second adjustment, so as to obtain the first initial disparity map.

The stereo matching device 400 in this embodiment of the present disclosure is capable of implementing the above-mentioned stereo matching method with a same beneficial effect, which will not be particularly defined herein.

### Fourth Embodiment

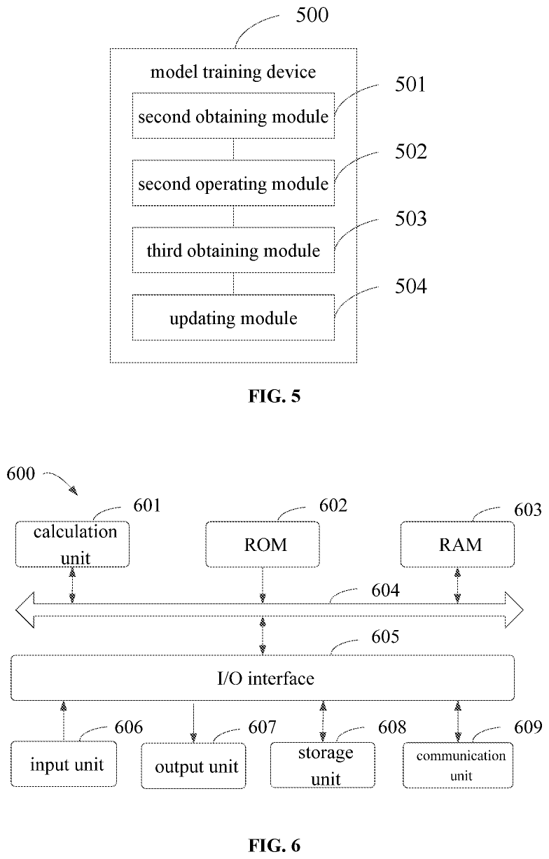

As shown in FIG. 5, the present disclosure provides in this embodiment a model training device 500, which includes: a second obtaining module 501 configured to obtain a train sample image, the train sample image including a third binocular image and a label disparity map of the third binocular image; a second operating module 502 configured to input the third binocular image into an object model for a second operation to obtain a third initial disparity map of the third binocular image and a second offset disparity map with respect to the third initial disparity map, the third initial disparity map being obtained through stereo matching on a fourth binocular image corresponding to the third binocular image, a size of the fourth binocular image being smaller than a size of the third binocular image, the second offset disparity map being obtained through stereo matching on the third binocular image within a predetermined disparity offset range; a third obtaining module 503 configured to obtain a network loss of the object model in accordance with the third initial disparity map, the second offset disparity map and the label disparity map; and an updating module 504 configured to update a network parameter of the object model in accordance with the network loss.

In a possible embodiment of the present disclosure, the third obtaining module 503 includes: a loss obtaining unit configured to obtain a first loss between the label disparity map and the third initial disparity map and a second loss between the label disparity map and the second offset disparity map; a loss aggregation unit configured to perform aggregation on the first loss and the second loss to obtain a disparity loss; and a loss determination unit configured to determine the network loss in accordance with the disparity loss.

In a possible embodiment of the present disclosure, the model training device further includes: a second aggregation module configured to perform aggregation on the third initial disparity map and the second offset disparity map to obtain a second target disparity map of the third binocular image; and a determination module configured to determine a smooth loss of the second target disparity map in accordance with an image gradient of the third binocular image and an image gradient of the second target disparity map, wherein the loss determination unit is specifically configured to perform aggregation on the disparity loss and the smooth loss to obtain the network loss.

The model training device 500 in this embodiment of the present disclosure is capable of implementing the above-mentioned model training method with a same beneficial effect, which will not be particularly defined herein.

The collection, storage, usage, processing, transmission, supply and publication of personal information involved in the embodiments of the present disclosure comply with relevant laws and regulations, and do not violate the principle of the public orders and statutes.

The present disclosure further provides in some embodiments an electronic device, a computer-readable storage medium and a computer program product.

FIG. 6 is a schematic block diagram of an exemplary electronic device 600 in which embodiments of the present disclosure may be implemented. The electronic device is intended to represent all kinds of digital computers, such as a laptop computer, a desktop computer, a work station, a personal digital assistant, a server, a blade server, a main frame or other suitable computers. The electronic device may also represent all kinds of mobile devices, such as a personal digital assistant, a cell phone, a smart phone, a wearable device and other similar computing devices. The components shown here, their connections and relationships, and their functions, are meant to be exemplary only, and are not meant to limit implementations of the present disclosure described and/or claimed herein.

As shown in FIG. 6, the electronic device 600 includes a computing unit 601 configured to execute various processings in accordance with computer programs stored in a Read Only Memory (ROM) 602 or computer programs loaded into a Random Access Memory (RAM) 603 via a storage unit 608. Various programs and data desired for the operation of the electronic device 600 may also be stored in the RAM 603. The computing unit 601, the ROM 602 and the RAM 603 may be connected to each other via a bus 604. In addition, an input/output (I/O) interface 605 may also be connected to the bus 604.

Multiple components in the electronic device 600 are connected to the I/O interface 605. The multiple components include: an input unit 606, e.g., a keyboard, a mouse and the like; an output unit 606, e.g., a variety of displays, loudspeakers, and the like; a storage unit 608, e.g., a magnetic disk, an optic disk and the like; and a communication unit 609, e.g., a network card, a modem, a wireless transceiver, and the like. The communication unit 609 allows the electronic device 600 to exchange information/data with other devices through a computer network and/or other telecommunication networks, such as the Internet.

The computing unit 601 may be any general purpose and/or special purpose processing components having a processing and computing capability. Some examples of the computing unit 601 include, but are not limited to: a central processing unit (CPU), a graphic processing unit (GPU), various special purpose artificial intelligence (AI) computing chips, various computing units running a machine learning model algorithm, a digital signal processor (DSP), and any suitable processor, controller, microcontroller, etc. The computing unit 601 carries out the aforementioned methods and processes, e.g., the stereo matching method or the model training method. For example, in some embodiments of the present disclosure, the stereo matching method or the model training method may be implemented as a computer software program tangibly embodied in a machine readable medium such as the storage unit 608. In some embodiments of the present disclosure, all or a part of the computer program may be loaded and/or installed on the electronic device 600 through the ROM 602 and/or the communication unit 609. When the computer program is loaded into the RAM 603 and executed by the computing unit 601, one or more steps of the foregoing stereo matching method or the model training method may be implemented. Optionally, in some other embodiments of the present disclosure, the computing unit 601 may be configured in any other suitable manner (e.g., by means of firmware) to implement the stereo matching method or the model training method.

Various implementations of the aforementioned systems and techniques may be implemented in a digital electronic circuit system, an integrated circuit system, a field-programmable gate array (FPGA), an application specific integrated circuit (ASIC), an application specific standard product (ASSP), a system on a chip (SOC), a complex programmable logic device (CPLD), computer hardware, firmware, software, and/or a combination thereof. The various implementations may include an implementation in form of one or more computer programs. The one or more computer programs may be executed and/or interpreted on a programmable system including at least one programmable processor. The programmable processor may be a special purpose or general purpose programmable processor, may receive data and instructions from a storage system, at least one input device and at least one output device, and may transmit data and instructions to the storage system, the at least one input device and the at least one output device.

Program codes for implementing the methods of the present disclosure may be written in one programming language or any combination of multiple programming languages. These program codes may be provided to a processor or controller of a general purpose computer, a special purpose computer, or other programmable data processing device, such that the functions/operations specified in the flow diagram and/or block diagram are implemented when the program codes are executed by the processor or controller. The program codes may be run entirely on a machine, run partially on the machine, run partially on the machine and partially on a remote machine as a standalone software package, or run entirely on the remote machine or server.

In the context of the present disclosure, the machine readable medium may be a tangible medium, and may include or store a program used by an instruction execution system, device or apparatus, or a program used in conjunction with the instruction execution system, device or apparatus. The machine readable medium may be a machine readable signal medium or a machine readable storage medium. The machine readable medium includes, but is not limited to: an electronic, magnetic, optical, electromagnetic, infrared, or semiconductor system, device or apparatus, or any suitable combination thereof. A more specific example of the machine readable storage medium includes: an electrical connection based on one or more wires, a portable computer disk, a hard disk, a random access memory (RAM), a read only memory (ROM), an erasable programmable read only memory (EPROM or flash memory), an optic fiber, a portable compact disc read only memory (CD-ROM), an optical storage device, a magnetic storage device, or any suitable combination thereof.

To facilitate user interaction, the system and technique described herein may be implemented on a computer. The computer is provided with a display device (for example, a cathode ray tube (CRT) or liquid crystal display (LCD) monitor) for displaying information to a user, a keyboard and a pointing device (for example, a mouse or a track ball). The user may provide an input to the computer through the keyboard and the pointing device. Other kinds of devices may be provided for user interaction, for example, a feedback provided to the user may be any manner of sensory feedback (e.g., visual feedback, auditory feedback, or tactile feedback); and input from the user may be received by any means (including sound input, voice input, or tactile input).

The system and technique described herein may be implemented in a computing system that includes a back-end component (e.g., as a data server), or that includes a middle-ware component (e.g., an application server), or that includes a front-end component (e.g., a client computer having a graphical user interface or a Web browser through which a user can interact with an implementation of the system and technique), or any combination of such back-end, middleware, or front-end components. The components of the system can be interconnected by any form or medium of digital data communication (e.g., a communication network). Examples of communication networks include a local area network (LAN), a wide area network (WAN) and the Internet.

The computer system can include a client and a server. The client and server are generally remote from each other and typically interact through a communication network. The relationship of client and server arises by virtue of computer programs running on respective computers and having a client-server relationship to each other. The server may be a cloud server, a server of a distributed system, or a server combined with blockchain.

It should be appreciated that, all forms of processes shown above may be used, and steps thereof may be reordered, added or deleted. For example, as long as expected results of the technical solutions of the present disclosure can be achieved, steps set forth in the present disclosure may be performed in parallel, performed sequentially, or performed in a different order, and there is no limitation in this regard.

The foregoing specific implementations constitute no limitation on the scope of the present disclosure. It is appreciated by those skilled in the art, various modifications, combinations, sub-combinations and replacements may be made according to design requirements and other factors. Any modifications, equivalent replacements and improvements made without deviating from the spirit and principle of the present disclosure shall be deemed as falling within the scope of the present disclosure.

What is claimed is:

1. A computer-implemented stereo matching method, comprising:
obtaining a first binocular image;
inputting the first binocular image into an object model for a first operation to obtain a first initial disparity map and a first offset disparity map with respect to the first initial disparity map; and
performing aggregation on the first initial disparity map and the first offset disparity map to obtain a first target disparity map of the first binocular image,
wherein the first initial disparity map is obtained through stereo matching on a second binocular image corresponding to the first binocular image, a size of the second binocular image is smaller than a size of the first binocular image, and the first offset disparity map is obtained through stereo matching on the first binocular image within a predetermined disparity offset range.

2. The computer-implemented stereo matching method according to claim 1, wherein the inputting the first binocular image into the object model for the first operation to obtain the first initial disparity map of the first binocular image comprises:
performing first adjustment on the size of the first binocular image to obtain the second binocular image, the first adjustment being used to reduce the size of the first binocular image;
performing stereo matching on the second binocular image within a maximum disparity range of the second binocular image to obtain a second initial disparity map of the second binocular image;
performing second adjustment on a size of the second initial disparity map, the second adjustment being used to increase the size of the second disparity map, the first adjustment corresponding to the second adjustment; and
adjusting a disparity value of each pixel point in the second initial disparity map obtained through the second adjustment, so as to obtain the first initial disparity map.

3. The computer-implemented stereo matching method according to claim 2, wherein the performing the stereo matching in accordance with the second binocular image within the maximum disparity range of the second binocular image to obtain the second initial disparity map of the second binocular image comprises:
with respect to each pixel point of the first binocular image, calculating a matching cost within the maximum disparity range of the second binocular image to obtain a cost volume of the pixel point, performing cost aggregation on the cost volume through convolutional operation to obtain a cost-aggregated cost volume, predicting a disparity probability in accordance with the cost-aggregated cost volume, solving a confidence level of each disparity value of each pixel point within the maximum disparity range, and determining an optimal disparity value of each pixel point in the second binocular image in accordance with the predicted probability and the maximum disparity range, so as to obtain the disparity map of the second binocular image through the formula:
D_{coarse}^{1/N}=Σᵢ₌₁^{D}^{ₘₐₓ}^{′}pᵢDᵢ,
where D_{coarse} is the disparity map of the second binocular image, Dₘₐₓ′ is a maximum disparity value of the second binocular image, the maximum disparity range of the second binocular image is 1˜Dₘₐₓ′, Dᵢ is a disparity value within the maximum disparity range, pᵢ is the confidence level, and i is a disparity value of the second binocular image within the maximum disparity range.

4. The computer-implemented stereo matching method according to claim 1, wherein the obtaining the first binocular image comprises at least one of:
capturing a binocular image in a same scenario directly through a binocular camera, and taking the binocular image as the first binocular image;
obtaining a pre-stored binocular image as the first binocular image;
receiving a binocular image from the other electronic device as the first binocular image; or
downloading a binocular image from a network as the first binocular image.

5. The computer-implemented stereo matching method according to claim 1, wherein the first offset disparity map is obtained by a neural network mode through stereo matching in accordance with the first binocular image within a predetermined disparity offset range, and the neural network model is a convolutional neural network or a residual neural network ResNet.

6. A computer-implemented model training method, comprising:
obtaining a train sample image, the train sample image comprising a third binocular image and a label disparity map of the third binocular image;
inputting the third binocular image into an object model for a second operation to obtain a third initial disparity map of the third binocular image and a second offset disparity map with respect to the third initial disparity map, the third initial disparity map being obtained through stereo matching on a fourth binocular image corresponding to the third binocular image, a size of the fourth binocular image being smaller than a size of the third binocular image, the second offset disparity map being obtained through stereo matching on the third binocular image within a predetermined disparity offset range;
obtaining a network loss of the object model in accordance with the third initial disparity map, the second offset disparity map and the label disparity map; and
updating a network parameter of the object model in accordance with the network loss.

7. The computer-implemented model training method according to claim 6, wherein the obtaining the network loss of the object model in accordance with the third initial disparity map, the second offset disparity map and the label disparity map comprises:
obtaining a first loss between the label disparity map and the third initial disparity map and a second loss between the label disparity map and the second offset disparity map;
performing aggregation on the first loss and the second loss to obtain a disparity loss; and
determining the network loss in accordance with the disparity loss.

8. The computer-implemented model training method according to claim 7, wherein prior to determining the network loss in accordance with the disparity loss, the model training method further comprises:
performing aggregation on the third initial disparity map and the second offset disparity map to obtain a second target disparity map of the third binocular image; and
determining a smooth loss of the second target disparity map in accordance with an image gradient of the third binocular image and an image gradient of the second target disparity map,
wherein the determining the network loss in accordance with the disparity loss comprises performing aggregation on the disparity loss and the smooth loss to obtain the network loss.

9. The computer-implemented stereo matching method according to claim 8, wherein the performing the aggregation on the disparity loss and the smooth loss to obtain the network loss comprises:
obtaining the network loss through superimposing the smooth loss of the second target disparity map on the disparity loss, and the smooth loss of the second target disparity map is calculated through the formula:
$${L}_{s m o o t h} = \vert \frac{\partial \hat{d 1}}{\partial x} \vert {e}^{- \vert \frac{\partial I}{\partial x} \vert} + \vert \frac{\partial \hat{d 1}}{\partial y} \vert {e}^{- \vert \frac{\partial I}{\partial γ} \vert ,}$$
where Lₛₘₒₒₜₕ represents the smooth loss of the second target disparity map, [symbol] represents the second target disparity map, I represents a label disparity map,
$$\frac{\partial *}{\partial x}$$
represents a gradient of the image in an x-axis direction, and
$$\frac{\partial *}{\partial y}$$
represents a gradient of the image in a y-axis direction.

10. An electronic device, comprising at least one processor, and a memory in communication with the at least one processor, wherein the memory is configured to store therein an instruction to be executed by the at least one processor, and the instruction is executed by the at least one processor so as to implement a computer-implemented stereo matching method, comprising:
obtaining a first binocular image;
inputting the first binocular image into an object model for a first operation to obtain a first initial disparity map and a first offset disparity map with respect to the first initial disparity map; and
performing aggregation on the first initial disparity map and the first offset disparity map to obtain a first target disparity map of the first binocular image,
wherein the first initial disparity map is obtained through stereo matching on a second binocular image corresponding to the first binocular image, a size of the second binocular image is smaller than a size of the first binocular image, and the first offset disparity map is obtained through stereo matching on the first binocular image within a predetermined disparity offset range.

11. The electronic device according to claim 10, wherein the inputting the first binocular image into the object model for the first operation to obtain the first initial disparity map of the first binocular image comprises:
performing first adjustment on the size of the first binocular image to obtain the second binocular image, the first adjustment being used to reduce the size of the first binocular image;
performing stereo matching on the second binocular image within a maximum disparity range of the second binocular image to obtain a second initial disparity map of the second binocular image;
performing second adjustment on a size of the second initial disparity map, the second adjustment being used to increase the size of the second disparity map, the first adjustment corresponding to the second adjustment; and
adjusting a disparity value of each pixel point in the second initial disparity map obtained through the second adjustment, so as to obtain the first initial disparity map.

12. The electronic device according to claim 11, wherein the performing the stereo matching in accordance with the second binocular image within the maximum disparity range of the second binocular image to obtain the second initial disparity map of the second binocular image comprises:
with respect to each pixel point of the first binocular image, calculating a matching cost within the maximum disparity range of the second binocular image to obtain a cost volume of the pixel point, performing cost aggregation on the cost volume through convolutional operation to obtain a cost-aggregated cost volume, predicting a disparity probability in accordance with the cost-aggregated cost volume, solving a confidence level of each disparity value of each pixel point within the maximum disparity range, and determining an optimal disparity value of each pixel point in the second binocular image in accordance with the predicted probability and the maximum disparity range, so as to obtain the disparity map of the second binocular image through the formula:
D_{coarse}^{1/N}=Σᵢ₌₁^{D}^{ₘₐₓ}^{′}pᵢDᵢ,
where D_{coarse}^{1/N} is the disparity map of the second binocular image, Dₘₐₓ′ is a maximum disparity value of the second binocular image, the maximum disparity range of the second binocular image is 1˜Dₘₐₓ′, Dᵢ is a disparity value within the maximum disparity range, pᵢ is the confidence level, and i is a disparity value of the second binocular image within the maximum disparity range.

13. The electronic device according to claim 10, wherein the obtaining the first binocular image comprises at least one of:
capturing a binocular image in a same scenario directly through a binocular camera, and taking the binocular image as the first binocular image;
obtaining a pre-stored binocular image as the first binocular image;
receiving a binocular image from the other electronic device as the first binocular image; or
downloading a binocular image from a network as the first binocular image.

14. The electronic device according to claim 10, wherein the first offset disparity map is obtained by a neural network mode through stereo matching in accordance with the first binocular image within a predetermined disparity offset range, and the neural network model is a convolutional neural network or a residual neural network ResNet.

15. An electronic device, comprising at least one processor, and a memory in communication with the at least one processor, wherein the memory is configured to store therein an instruction to be executed by the at least one processor, and the instruction is executed by the at least one processor so as to implement the computer-implemented model training method according to claim 6.

16. The electronic device according to claim 15, wherein the obtaining the network loss of the object model in accordance with the third initial disparity map, the second offset disparity map and the label disparity map comprises:
obtaining a first loss between the label disparity map and the third initial disparity map and a second loss between the label disparity map and the second offset disparity map;
performing aggregation on the first loss and the second loss to obtain a disparity loss; and
determining the network loss in accordance with the disparity loss.

17. The electronic device according to claim 16, wherein prior to determining the network loss in accordance with the disparity loss, the computer-implemented model training method further comprises:
performing aggregation on the third initial disparity map and the second offset disparity map to obtain a second target disparity map of the third binocular image; and
determining a smooth loss of the second target disparity map in accordance with an image gradient of the third binocular image and an image gradient of the second target disparity map,
wherein the determining the network loss in accordance with the disparity loss comprises performing aggregation on the disparity loss and the smooth loss to obtain the network loss.

18. The electronic device according to claim 17, wherein the performing the aggregation on the disparity loss and the smooth loss to obtain the network loss comprises:
obtaining the network loss through superimposing the smooth loss of the second target disparity map on the disparity loss, and the smooth loss of the second target disparity map is calculated through the formula:
$${L}_{s m o o t h} = \vert \frac{\partial \hat{d 1}}{\partial x} \vert {e}^{- \vert \frac{\partial I}{\partial x} \vert} + \vert \frac{\partial \hat{d 1}}{\partial y} \vert {e}^{- \vert \frac{\partial I}{\partial γ} \vert ,}$$
where Lₛₘₒₒₜₕ represents the smooth loss of the second target disparity map, [symbol] represents the second target disparity map, I represents a label disparity map,
$$\frac{\partial *}{\partial x}$$
represents a gradient of the image in an x-axis direction, and
$$\frac{\partial *}{\partial y}$$
represents a gradient of the image in a y-axis direction.

19. A non-transitory computer-readable storage medium storing therein a computer instruction, wherein the computer instruction is executed by a computer so as to implement the computer-implemented stereo matching method according to claim 1.

20. A non-transitory computer-readable storage medium storing therein a computer instruction, wherein the computer instruction is executed by a computer so as to implement the computer-implemented model training method according to claim 6.
